(19) United States
(12) Patent Application Publication
(10) Pub. No.: US 2009/0262524 A1
(43) Pub. Date: Oct. 22, 2009

(54) OUTDOOR LIGHTING DEVICE

(75) Inventor: Ga-Lane Chen, Santa Clara, CA (US)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/202,588

(22) Filed: Sep. 2, 2008

(30) Foreign Application Priority Data
Apr. 16, 2008 (CN) 200810301149.8

(51) Int. Cl. F21L 13/02

(52) U.S. Cl. 362/192

(57) ABSTRACT

An outdoor lighting device includes a printed circuit board having a first surface and an opposite second surface; a plurality of light emitting diodes mounted on the first surface of the printed circuit board; and an electric power supply system. The electric power supply system includes a fan having a plurality of blades, and an electric power generator. The fan is arranged over the second surface of the printed circuit board. The electric power generator is mechanically connected to the fan and configured for converting rotation of the fan into electric power for the light emitting diodes. The blades dissipate heat generated by the light emitting diodes in rotation.

### BACKGROUND

1. Technical Field

The present invention relates to lighting devices, and particularly, to an outdoor lighting device with light emitting diodes.

2. Description of Related Art

Light emitting diodes (LEDs), which are solid state light emitting elements, are widely used in lighting.

An LED is capable of producing a visible light in a certain wavelength, if an electric power is applied to the LED. However, 80% to 90% of the electrical energy is converted to heat, which needs to be dissipated, and only the small remainder is converted to the light.

Outdoors, when a plurality of LEDs are used, powering the LEDs and heat dissipating for the LEDs are difficult.

What is needed, therefore, is an outdoor lighting device, which overcomes the above problems.

### SUMMARY

An outdoor lighting device includes a printed circuit board having a first surface and an opposite second surface; a plurality of light emitting diodes mounted on the first surface of the printed circuit board; and an electric power supply system. The electric power supply system includes a fan having a plurality of blades, and an electric power generator. The fan is arranged over the second surface of the printed circuit board. The electric power generator is mechanically connected to the fan and configured for converting rotation of the fan into electric power for the light emitting diodes. The blades dissipate heat generated by the light emitting diodes in rotation.

Other novel features and advantages of the present outdoor lighting device will become more apparent from the following detailed description of embodiments when taken in conjunction with the accompanying drawings.

### BRIEF DESCRIPTION OF THE DRAWINGS

Many aspects of the outdoor lighting device can be better understood with reference to the following drawings. The components in the drawings are not necessarily drawn to scale, the emphasis instead being placed upon clearly illustrating the principles of the present outdoor lighting device. Moreover, in the drawings, like reference numerals designate corresponding parts throughout the several views.

FIG. 1 is a schematic view of an outdoor lighting device in accordance with a first embodiment of present invention.

FIG. 2 is a schematic view of a mechanical connection between the fan and the electric power generator of FIG. 1.

FIG. 3 is a block diagram showing an electrical connection between the electric power generator and the light emitting diode of FIG. 1.

FIG. 4 is a schematic view of an outdoor lighting device in accordance with a second embodiment of present invention.

### DETAILED DESCRIPTION OF THE EMBODIMENTS

Embodiments of the present outdoor lighting device will now be described in detail below and with reference to the drawings.

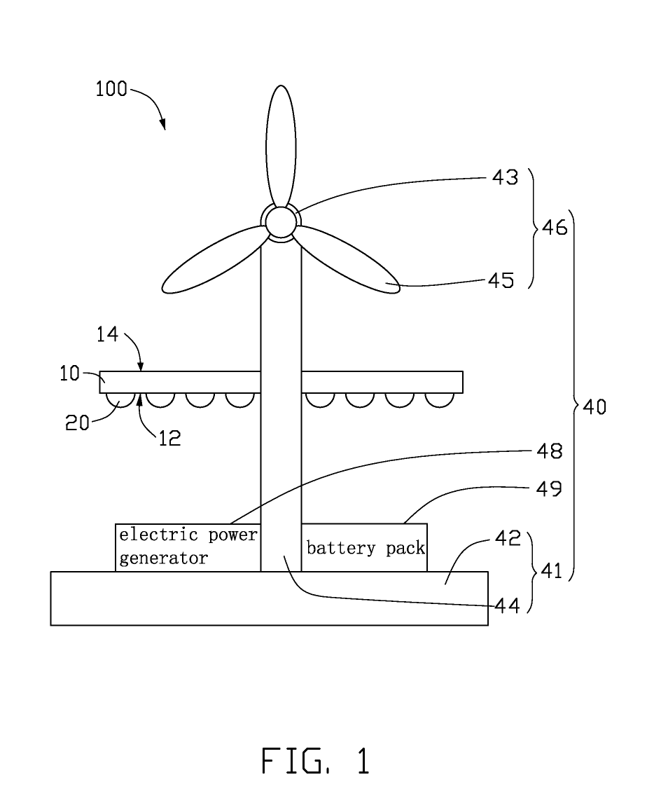

Referring to FIG. 1, an outdoor lighting device 100 in accordance with a first embodiment, is provided. The outdoor lighting device 100 includes a printed circuit board (PCB) 10, a plurality of light emitting diodes (LEDs) 20, and an electric power supply system 40.

The PCB 10 is metallic, and has a first surface 12 and an opposite second surface 14. The LEDs are mounted on the first surface 12, and are spaced apart from each other.

The electric power supply system 40 includes a supporter 41, an electric power generator 48, a battery pack 49, and an fan 46 having a shaft 43 and three blades 45 attached on the shaft 43. The supporter 41 includes a base 42 and an elongated post 44 attached on the base 42. The electric power generator 48 and the battery pack 49 are arranged on the base 42. The fan 46 is mounted on an end of the post 44. The printed circuit board 10 is also mounted on the post 44, between the fan 46 and the base 42.

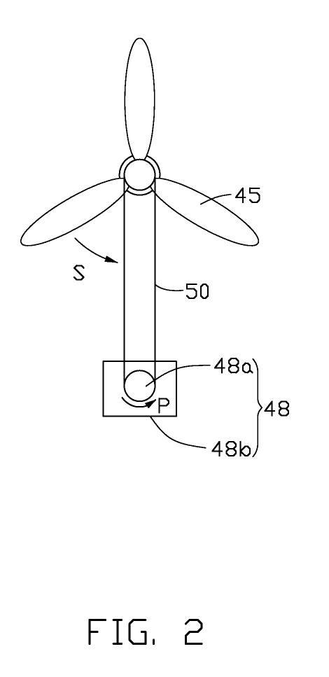

Referring to FIG. 2, the electric power generator 48 includes a rotator 48a and a stator 48b. The rotator 48a is mechanically connected to the shaft 43 of the fan 46 by a connection belt 50. When the blades 45 are blew to rotate by natural wind, e.g., in a direction as the arrowhead S shows, the shaft 43 rotates, and the rotator 48a is driven to rotate in a direction as the arrowhead S shows. The stator 48b generates and outputs an electric power when the rotator 48a rotates.

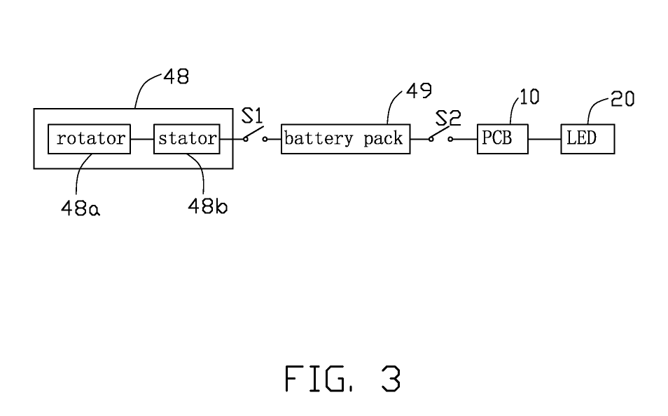

Referring to FIG. 3, the stator 48b is electrically connected to the battery pack 49 via a first switch S1, and the battery pack 49 is electrically connected to the PCB 10 via a second switch S2. The battery pack 49 stores electric power generated by the electric power generator 48 and supplies the electric power to the LEDs 20. The second switch S2 can be power off, when the LEDs 20 are not needed to work, e.g., at an environment with high brightness.

The blades 45 are arranged over the second surface 14 of the PCB 10, such that the blades 45 can dissipate heat generated by the LEDs 20 when they are rotated. In this way, heat dissipation and electric power for the LEDs can be carried out at the same time.

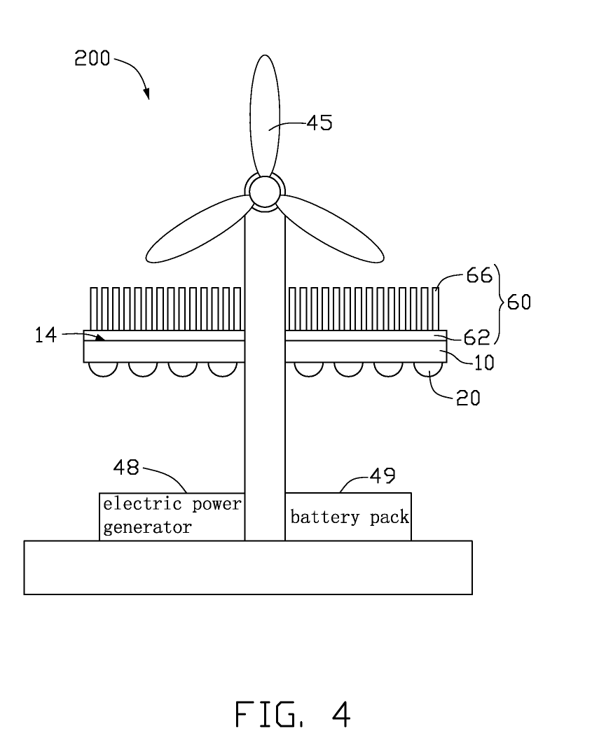

Referring to FIG. 4, an outdoor lighting device 200 in accordance with a second embodiment, is provided. The outdoor lighting device 200 is essentially similar to the outdoor lighting device 100 illustrated above, however, a heat sink 60 is attached on the second surface 14 of the PCB 10. The heat sink 60 includes a heat conducting plate 62 and a plurality of fins 66 extending from the heat conducting plate 62. Configuration and cooperation of the blades 45 and the heat sink 60 can provide a compact efficient heat dissipating module.

It is understood that the above-described embodiments are intended to illustrate rather than limit the invention. Variations may be made to the embodiments and methods without departing from the spirit of the invention. Accordingly, it is appropriate that the appended claims be construed broadly and in a manner consistent with the scope of the invention.

What is claimed is:

1. An outdoor lighting device comprising:
a printed circuit board having a first surface and an opposite second surface;
a plurality of light emitting diodes mounted on the first surface of the printed circuit board; and
an electric power supply system comprising a fan having a plurality of blades arranged over the second surface of the printed circuit board, and an electric power generator mechanically connected to the fan and configured for converting rotation of the fan into electric power for the light emitting diodes, the blades dissipating heat generated by the light emitting diodes in rotation.

2. The outdoor lighting device of claim 1, wherein the electric power supply system further comprises a battery pack, the electric power generator electrically connected to the printed circuit board via the battery pack.

3. The outdoor lighting device of claim 2, wherein the electric power generator comprises a rotator and stator, the rotator mechanically connected to the fan and driven to rotate by the fan, the stator electrically connected to the battery pack.

4. The outdoor lighting device of claim 1, wherein the electric power supply system further comprises a supporter having a base and an elongated post, the fan being arranged at an end of the post, the printed circuit board being mounted on the post, between the fan and the base.

5. The outdoor lighting device of claim 1, further comprising a heat sink attached on the second surface of the printed circuit board and under the fan.
